(19) United States
(12) Patent Application Publication
(10) Pub. No.: US 2021/0236906 A1
(43) Pub. Date: Aug. 5, 2021

(54) Straight shotz

(71) Applicant: Patrick Jopseph Feheley, Sarasota, FL (US)

(72) Inventor: Patrick Joseph Feheley, Sarasota, FL (US)

(73) Assignee: Kevin Michael Feheley, Sarasota, FL (US)

(21) Appl. No.: 16/873,105

(22) Filed: Feb. 3, 2020

(51) Int. Cl. A63B 71/00; A63B 53/04

(52) U.S. Cl. CPC A63B 71/0009; A63B 69/3691; A63B 2071/0018; A63B 53/0487

(57) ABSTRACT

The linear orientation of the user combined with a straight forward sliding stroke motion of present invention presents a novel new way to strike a golf ball toward the hole/target. By utilizing a linear line of site between the user's eyes, present invention, golf ball and the cup, this modern orientation of the golfer is similar to a marksman, the rifle, aiming site/scope and the bull's-eye of his target. While transversely rotating the body 90 degrees left or right (depending on handedness) compared to what has come before and incorporating the invention presented here, a new dimension in putting is opened, more accurately matching ones natural connection between their stance and aim. In nearly every other sport, this similar stance stoke/throw/shot is linear and constant due to its recognized effectiveness.

### FIELD OF INVENTION

The present invention relates to devices for putting the ball in the game of golf.

### BACKGROUND OF INVENTION

The present invention relates to the way someone engaged in putting interacts with the golf ball. The present invention also intends to allow those with certain disabilities a new tool allowing them access to the game of golf.

Current putting devices are operated with the golfer in suboptimal alignment, with the golfer stoking the ball at a 90 degree angle relative to the hole and the positioning of their body. Presently there is no solution for stroking a putt that puts the golfer, the ball, the putting device and the cup in direct (straight on) alignment.

### BRIEF SUMMARY OF THE INVENTION

The present invention seeks to provide a solution to this aiming discrepancy by allowing the golfer to both arrange their body in a straight line and stroke the ball in this direct alignment with the cup. This direct alignment increases proprioceptive connection between the golfer, the putting device, the ball and the cup. This direct alignment opens the door to a new dimension of accuracy in the putting aspect for the game of golf.

### BRIEF DESCRIPTION OF THE SEVERAL VIEWS OF THE DRAWINGS

FIG. 1 is a section view of invention highlighting 45° shaft placement, ¾″ inside hosel, 3″ low friction bottom for stroke stability and embodiment dimensions

FIG. 2 is a CAD rendering similar to FIG. 1 with detailed dimension

FIG. 3 is a technical CAD rendering of the present invention from a front face perspective, with embodiment dimensions of face width and stroke stability platform

FIG. 4 is a rear perspective of invention's back side

FIG. 5 is a view of invention from the top detailing hosel location, along the midline

FIG. 6 is a view of invention from the bottom highlighting total club head size as well as smaller surface footprint of stroke stability platform

FIG. 7 is a section view

FIG. 8 is a 45 degree view of slightly alternative embodiment highlighting 45 degree shaft placement along club head midline

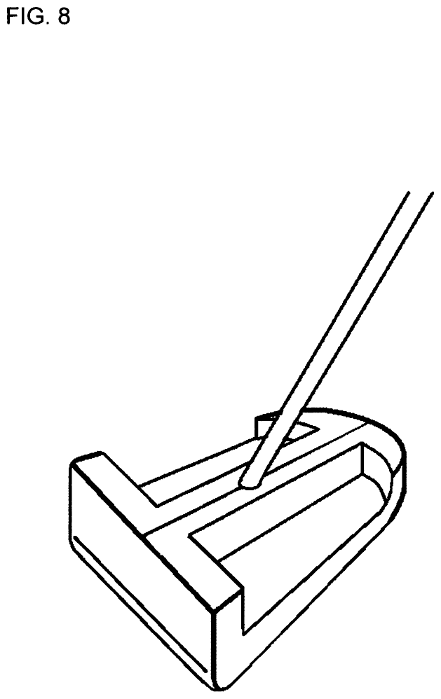

FIG. 9 is a 45 degree view of invention embodiment highlighting the sliding stroke motion with a golf ball for relative size comparisons

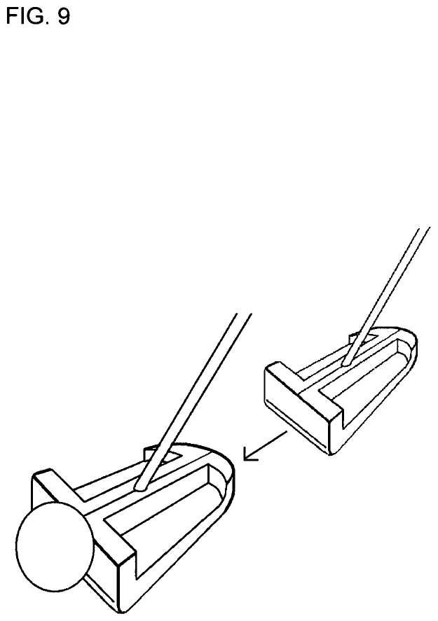

FIG. 10 is a two panel illustration of a golfer with original embodiment of invention utilizing sliding stroke motion to hit a golf ball

### DETAILED DESCRIPTION OF INVENTION

The present invention will now be described in full detail with reference to the drawings which are provided as illustrative example of the invention as to enable those skilled in the art to practice and build the invention.

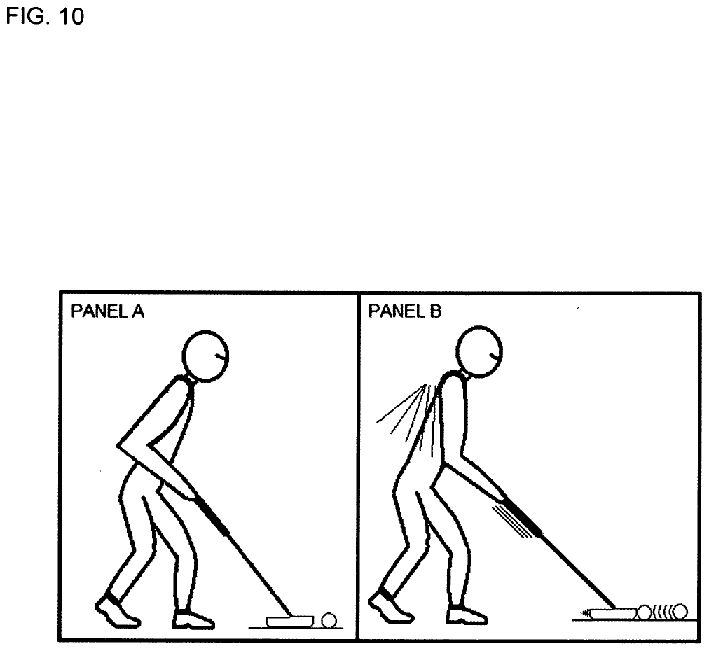

The present invention allows the golf enthusiast to experience an unprecedented proprioceptive connection between themselves and the cup. The present invention, in the field of putting in the game of golf, allows users to more directly aim their putting strokes via positioning of their body, present invention, golf ball and hole in a straight line as in FIG. 10. The figures and examples are not meant to limit the scope of the present invention. Moreover, where certain elements of the present invention can be partially or fully realized using known components, only those portions that are necessary for an understanding of the present invention will be described. Technically detailed descriptions of other portions of such known components (such as golf shaft manufacture) will be omitted so as not to obscure the invention.

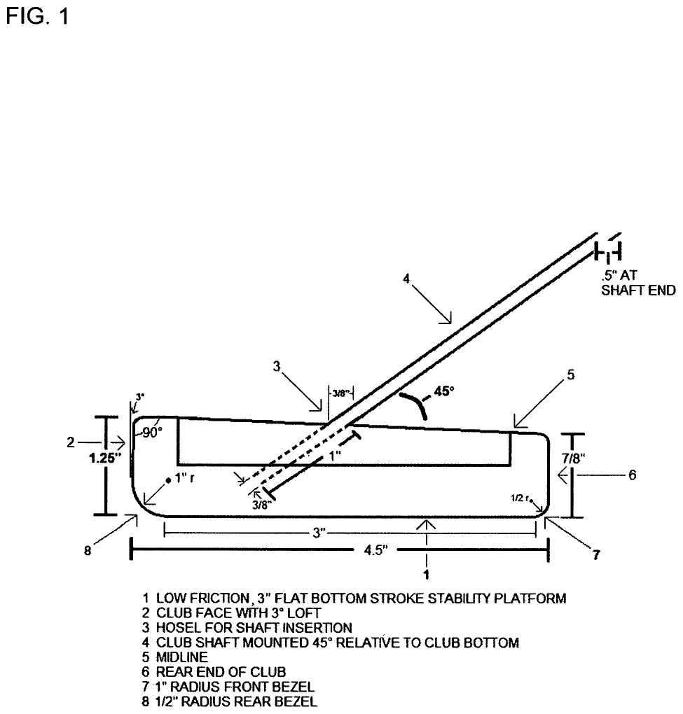

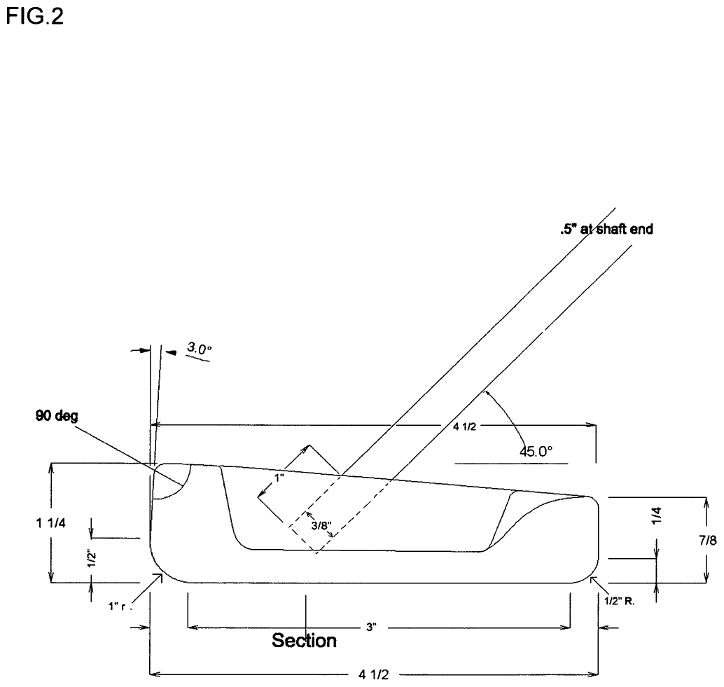

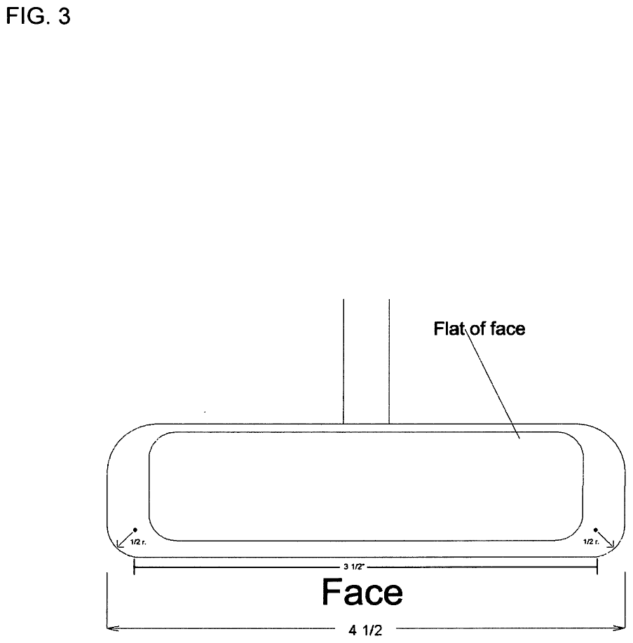

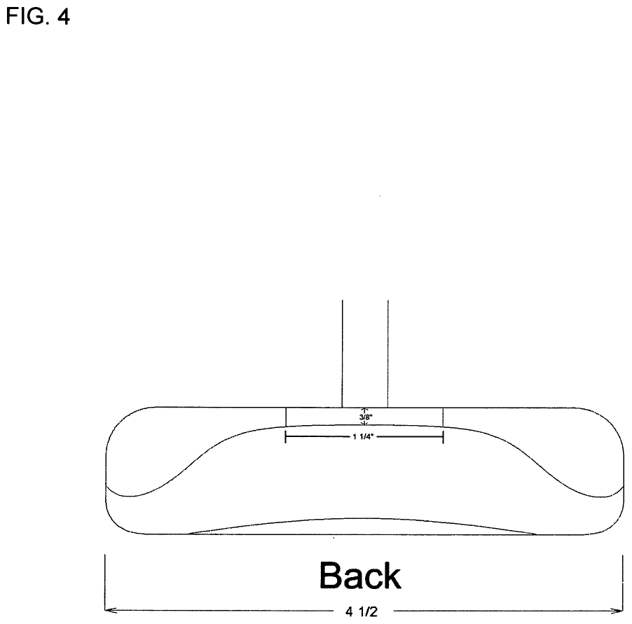

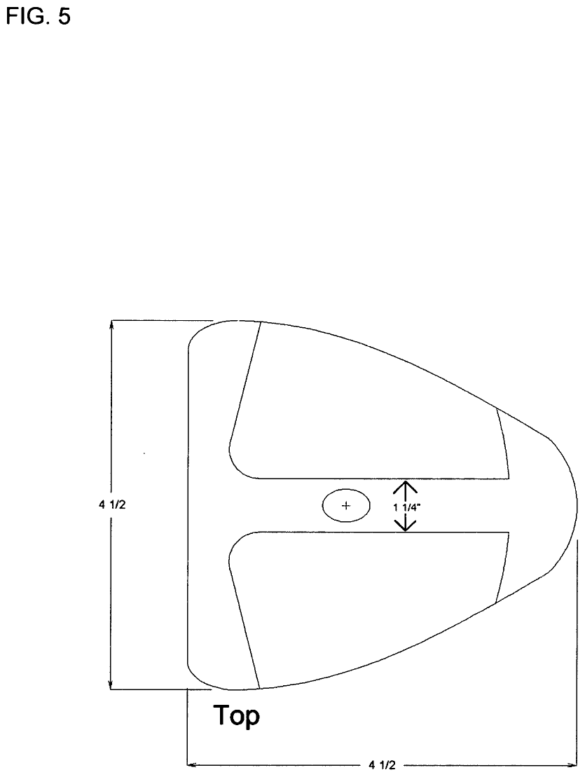

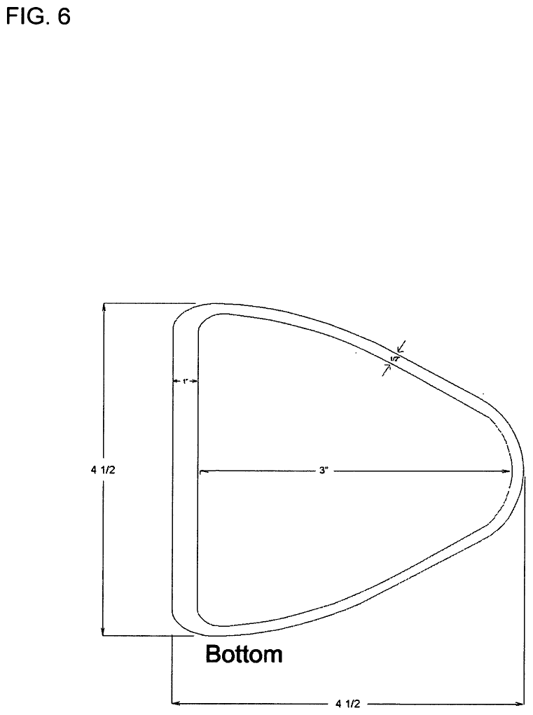

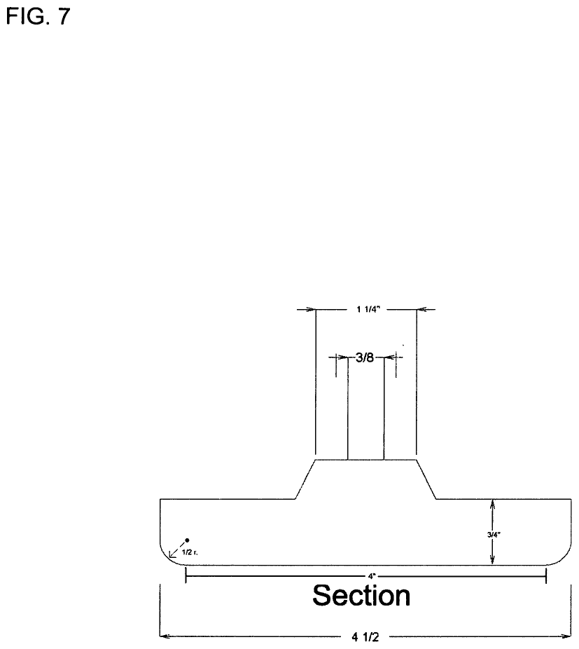

FIGS. 1-7 shows the present invention's dimensions from which an aluminum mold is made. A dense polymer is then injected into mold with 60 ton injection molding machine to form the club head. To form the 1″ long ⅜″ wide hosel opening for shaft emplacement (FIG. 1 #4), an insert with the same measurements is placed inside the mold during injection process. After the mold is open and formed invention club head is ejected, this insert is removed. The club shaft is secured into remaining hosel opening with epoxy resin. This shaft is mounted at a 45 degree angle relative to vertical and aligned directly with the midline of the club head, perpendicular to the club face. The bottom of club as seen in FIG. 6 is highly polished to create an extremely low friction surface, allowing the club head of present invention to slide freely over play surface.

While the preceding written description of the invention and stroke innovation enables one of ordinary skill to make and use what is considered presently to be the best mode thereof, those of ordinary skill will easily understand and appreciate the existence of variations, combinations, and equivalents of the specific embodiment, method and examples herein. Therefore, future embodiments should not be limited to these dimensions. For example, many versions of the invention will be built with different club head aesthetics, and materials. Only the design requirements to build the present basic invention have been discussed. The invention should consequently not be limited by the herein described exemplification and approach, but by all subsequent embodiments and methods within the scope and spirit of the invention.

1. A linear orientation of the user, present invention, golf ball and hole/target.
Utilizing a linear line of site between their eyes, club head, golf ball and the cup, this novel orientation of the golfer is similar to a marksman, the rifle, aiming site/scope and the bull's-eye of his target. While transversely rotating the body 90 degrees left or right (depending on handedness) compared to what has come before and incorporating the invention presented here, a new dimension in putting is opened, more accurately matching ones natural connection between one's stance and aim. In almost every other sport, this similar stance stoke/throw/shot is linear and undeviating due to its recognized effectiveness.

2. A linear sliding stroke motion of present invention.
The present invention has the golf shaft oriented 45 degrees to the vertical, directly along the cub head midline to allow for a smooth connection between the low friction bottom and the golf course surface. Combined with the orientation of golfer in claim 1, this club and shaft orientation allows for a novel method of striking the ball with greater accuracy than what has come before. This is referred to as the sliding stroke motion. FIG. 10 illustrates this sliding stroke motion combined with claim 1 golfer orientation via a two panel drawing of the invention being used.

3. Enabling those with disabilities a new tool in order to regain their capability of putt on a golf course, mini golf course or any similar surface such as an indoor putting game.
Disabilities such as missing a limb, necessitating a wheelchair, lacking stability, or lacking balance, are not required necessities to use this new tool.

4. Ambidexterity of invention.
The present invention is unique in this regards.
